(19) United States
(12) Patent Application Publication
(10) Pub. No.: US 2009/0205295 A1
(43) Pub. Date: Aug. 20, 2009

(54) RIDING SADDLE WITH BODY-MATCHING SEAT PADDING

(75) Inventors: Hugo Odermatt, Oberdorf (CH); Frank Stubben, Stans (CH); Ralph Stubben, Krefeld (DE)

Correspondence Address: LERNER GREENBERG STEMER LLP, P O BOX 2480, HOLLYWOOD, FL, 33022-2480, US

(73) Assignee: Stubben GmbH, Riding Equipment, Stans (CH)

(21) Appl. No.: 12/395,796

(22) Filed: Mar. 2, 2009

Related U.S. Application Data
(63) Continuation of application No. PCT/EP2007/058763, filed on Aug. 23, 2007.

(30) Foreign Application Priority Data
Aug. 30, 2006 (DE) 20 2006 013 289.9

(51) Int. Cl. B68C 1/02; B68C 1/04

(52) U.S. Cl. 54/44.3; 54/44.5; 54/44.7

(57) ABSTRACT

A riding saddle includes a saddle tree determining a saddle structure and seat padding thereon. The seat padding, in a supporting region for a rider's posterior, has two padded elevations projecting from a basic saddle surface and mutually separated by a flat depression. Dimensioning and configuration of the elevations and depression relieve a rider's buttocks from load during riding by more greatly padding ischial protuberances than buttocks. The elevations have a surface, at least 150 cm², causing at least the ischial protuberances of riders of different height and different distances between the ischial protuberances to be padded in different sitting positions. The elevations have rounded outer contours, are matched to the saddle shape, are formed by two separate pads with the depression formed therebetween to the basic saddle surface below the pads. The saddle increases comfort by distributing weight over the posterior surface and saddle, providing secure and unstressed seating.

### CROSS-REFERENCE TO RELATED APPLICATION

This is a continuing application, under 35 U.S.C. § 120, of copending International Application No. PCT/EP2007/058763, filed Aug. 23, 2007, which designated the United States; this application also claims the priority, under 35 U.S.C. § 119, of German Patent Application No. 20 2006 013 289.9, filed Aug. 30, 2006; the prior applications are herewith incorporated by reference in their entirety.

### BACKGROUND OF THE INVENTION

### Field of the Invention

The present invention relates to seat padding of a riding saddle. A saddle has the task of providing a connection between a horse and a person that meets the requirements of both of them. There are therefore many details which should be taken into consideration when matching a saddle to a horse's back, but those details are not the subject matter of the present invention. However, the comfort of the rider should also be taken into consideration in order to provide optimum conditions for every type of riding sport.

A typical riding saddle has a saddle structure to which seat padding is fitted on the upper side thereof. A saddle tree and tensioning straps, which determine the shape of the seat, are also provided, as seen in German Published, Non-Prosecuted Patent Application DE 103 36 468 A1. The upper side has a basic saddle surface which forms a type of seat shell for the posterior. The rear part of the seat shell is generally raised to a relatively high degree to a rider's lower back region, and there is as uniform and large as possible a supporting surface for the posterior. If the anatomy of the human posterior is considered, it is apparent, for a conventional riding saddle, that the region around the coccyx of the person in question is subjected to a greater load by the seat shell, which is raised to the rear, than the ischial protuberances which should likewise support part of the weight of the person in question when he or she is seated. The loads to which the posterior is subjected can thus become disproportionate, which, after some time, may be found unpleasant or uncomfortable and also have a negative effect on the stability of the sitting posture.

### SUMMARY OF THE INVENTION

It is accordingly an object of the invention to provide a riding saddle with body-matching seat padding, which overcomes the hereinafore-mentioned disadvantages of the heretofore-known devices of this general type through the use of suitable seat padding.

With the foregoing and other objects in view there is provided, in accordance with the invention, a riding saddle, comprising a saddle structure, a basic saddle surface, and seat padding fitted on the saddle structure. The seat padding has two padded elevations in a supporting region for a rider's posterior. The padded elevations project from the basic saddle surface and a planar depression separates the padded elevations from each other. The elevations and the depression are dimensioned and configured to cause a rider's coccyx to be relieved from load during riding by padding the rider's ischial protuberances more greatly than the rider's coccyx.

The invention displaces the surface load on the posterior or buttocks from the center to the outside in such a way that there is less load resting on the coccyx and more load resting on the region of the ischial protuberances. This brings about a greater degree of comfort for the rider and at the same time widens the supporting base such that a secure seat is ensured.

Since a rider changes his or her position in the saddle within certain limits and, under some circumstances, a saddle will also be used by different riders, it is advantageous to configure the elevations with a surface of such a size that the desired reinforced padding within a wide region under the ischial protuberances is ensured. For this purpose, the elevations have a surface of at least 150 cm² in each case, preferably of more than 200 cm² in each case, in particular even more than 300 cm². In a preferred embodiment of the invention, the elevations are each approximately kidney-shaped and are longer in the longitudinal direction of the saddle than in the transverse direction. The depression runs in the longitudinal direction approximately in the center of the saddle and preferably has a width of at least 2 cm, in particular more than 4 cm. The depression typically has a narrowest point approximately in the center of the seat shell and widens to the front and to the rear through the use of slightly outwardly curved edges of the elevations. In this case, the depression preferably has a width between 4 and 10 cm. It reaches in this case as far as the basic saddle surface under the elevations and is disposed and dimensioned in such a manner that a rider's coccyx is positioned in the region above the depression during riding and is therefore subjected to less load than in the case of conventional saddles even while the rider is sitting in the saddle according to the invention.

The elevations are preferably rounded gently with respect to their outer contours and are matched to the shape of the saddle. In particular, they can run laterally in the outer region of the saddle as far as the seams which are present there.

Since the primary purpose is to relieve the coccyx of load while the remaining load to which the posterior is subjected is to be as uniform as possible, the elevations are constructed in such a manner that they have an approximately constant height over most of their surface and drop away toward their outer contours, and preferably merge uniformly over an edge region with a width of 1 to 4 cm into the basic saddle surface. This permits a uniform leather layer, which is precisely matched to the shape of the elevations, to be used as the surface of the seat region. If the elevations are located at the correct points and so too is the depression, it does not matter whether or not the elevations are connected to each other by bridges. However, an embodiment is preferred in which the two elevations are formed by two completely separate pads between which the depression reaches as far as the basic saddle surface under the pads and thus forms a continuous valley along the centerline of the saddle. This embodiment does not require any excessive deformations for matching the leather layer as the surface of the seat region and also permits a substantially crease-free structure of the seat surface even during prolonged use. The seat surface is preferably formed from a leather layer which has a thickness of between 1 and 3 mm, in particular approximately 2.0 to 2.2 mm. It is particularly favorable if the leather layer does not have any seams over the entire seat region.

In a preferred embodiment, the elevations are composed of foam, in particular polyurethane or polyethylene foam. Foams of this type have proven particularly suitable for padding riding saddles. In principle, however, it is also possible to use other materials for the elevations, with it being possible, depending in each case on the desired properties, to use silicone foam, an addition-crosslinked two-component gel, preferably deliquidized gel, if appropriate also with portions of foam, reused wool or natural wool or felt.

In its preferred embodiment, a riding saddle according to the invention is constructed in such a manner that the basic saddle surface is formed by an underlayer, preferably of rubber which is approximately 14 mm thick, and by an intermediate layer, preferably made of jute fabric, disposed on the underlayer. The basic saddle surface can then be covered with a leather layer forming the saddle surface, with the elevations being adhesively bonded to the lower side of the saddle surface beforehand. The basic saddle surface, leather layer and elevations are preferably adhesively bonded to one another, with an intermediate layer of jute fabric resulting in a particularly stable structure. The adhesive bonding brings about a durable, substantially crease-free seat, with it being possible for the side walls of the depression to accommodate creases which may form, as a result of which such creases do not have any effect whatsoever on comfort.

Other features which are considered as characteristic for the invention are set forth in the appended claims.

Although the invention is illustrated and described herein as embodied in a riding saddle with body-matching seat padding, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, approximately top-plan view of a saddle according to the invention; and

FIG. 2 is a cross-sectional view of such a saddle, which is taken along a line II-II of FIG. 1 in the direction of the arrows, in a region of elevations.

### DETAILED DESCRIPTION OF THE INVENTION

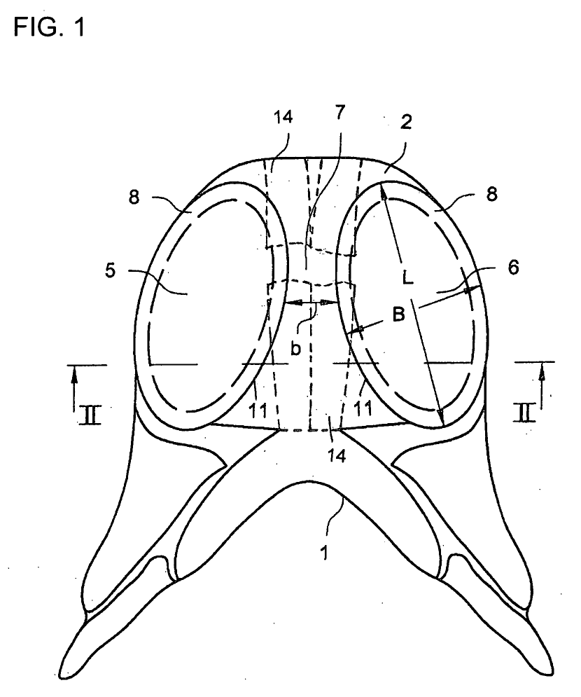

Referring now to the figures of the drawings in detail and first, particularly, to FIG. 1 thereof, there is seen a riding saddle 1 having a basic saddle surface 2 from which elevations 5, 6 project. The elevations 5, 6 are separated from each other by a depression 7. The depression 7 reaches as far as the basic saddle surface 2. The elevations 5, 6 have a length L of, for example, approximately 20 cm in the longitudinal direction of the saddle 1 and a respective width B which is smaller than the length L and is, for example, approximately 12 cm. The depression 7 has its smallest width b of, for example, approximately 4 cm approximately in the center of the basic saddle surface 2 and widens slightly to the rear and to the front. The elevations 5, 6 merge gently into the basic saddle surface 2 in their edge regions 8. The elevations 5, 6 are approximately kidney-shaped and their outer contour 11 is rounded inward and matched to the shape of the saddle 1 in the outer region thereof. Tensioning straps 14 determine the shape of the seat, as will be explained in more detail below. The tensioning straps 14 are broken off in the middle to show the depression 7 and are illustrated in broken lines because they are located below the depression 7.

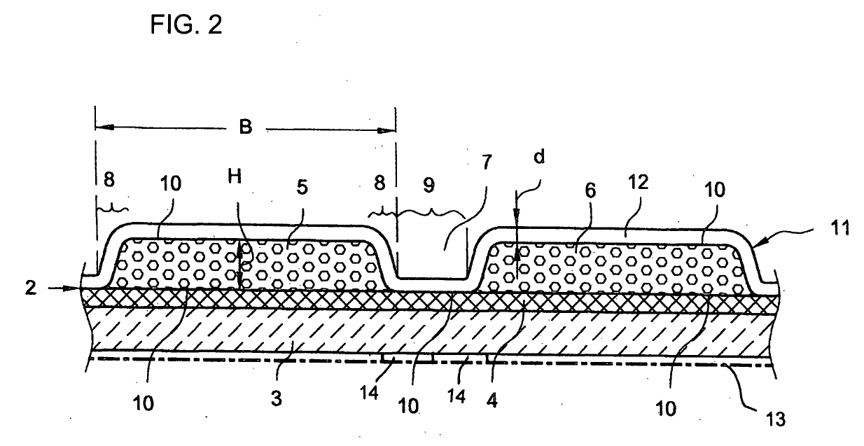

FIG. 2 shows a diagrammatic cross section along the line 11-11 in FIG. 1 through the seat region of the riding saddle 1. An underlayer 3 is formed from a layer of rubber approximately 14 mm thick, and an intermediate layer 4, preferably made of jute fabric, is fitted thereon. A saddle tree 13, in particular a steel spring tree, which determines a saddle structure, is disposed below the underlayer 3. The tensioning straps 14 may be seen between the underlayer 3 and the saddle tree 13. The elevations 5 and 6 have a height H of between 5 and 40 mm, preferably approximately 15 mm, and merge again gently in their edge regions 8 into the basic saddle surface 2. The elevations 5, 6 are covered by a leather layer 12 having a thickness d of preferably approximately 2.0 to 2.2 mm. The leather layer 12 is adhesively bonded on the outside, at the front and at the rear and in the region of the depression 7, to the underlayer 3 and the intermediate layer 4. In the region of the depression 7, a region 9 with a width of a few centimeters is adhesively bonded in a planar manner, level with the basic saddle surface 2, thus resulting there in a region through which a rider's coccyx is exposed to less pressure than in the case of conventional saddles if he/she is sitting in the saddle. The elevations 5, 6 absorb a greater part of the rider's weight over the region of the rider's ischial protuberances, thus resulting overall in a very stable sitting position with the compressive forces being distributed from the inside to the outside. Adhesive layers 10, which function as connections between the elevations 5, 6 and the leather layer 12 as well as the intermediate layer 4, permit production of the seat surface without seams.

An embodiment of a saddle according to the invention is produced in the following steps:

The shape of the seat is determined by the tensioning straps 14 starting from the saddle tree 13, in particular a steel spring tree, determining the saddle structure. The flexibility of the saddle tree is taken into consideration in the process. The underlayer 3, preferably a layer of rubber of approximately 14 mm, is then adhesively bonded onto the tensioned straps 14. The underlayer has a highly flexible effect. A saddle seat leather having a thickness of 2.0 to 2.2 mm is scoured with its stretchability being taken into consideration and is cut to the final seat shape and size. The elevations 5, 6, preferably prepared foam components, are adhesively bonded onto the underside of the preshaped seat leather. The leather and foam cores are fixed to and stabilized with a thin jute fabric and are adhesively bonded to the underlayer 3. Small saddle pockets are subsequently stitched to the seat leather. Finally, the seat leather is tensioned over the saddle tree provided therefor.

In the case of a saddle according to the invention, a rider's coccyx is relieved of load, with the rider at the same time having his legs drop down more steeply and therefore experiencing greater contact with the horse. Overall, this increases the comfort, in particular if the rider spends a relatively long time in the saddle.

1. A riding saddle, comprising:
a saddle structure;
a basic saddle surface;
seat padding fitted on said saddle structure, said seat padding having two padded elevations in a supporting region for a rider's posterior, said padded elevations projecting from said basic saddle surface; and
a planar depression separating said padded elevations from each other;
said elevations and said depression being dimensioned and configured to cause a rider's coccyx to be relieved from load during riding by padding the rider's ischial protuberances more greatly than the rider's coccyx.

2. The riding saddle according to claim 1, wherein said elevations have a surface with a size permitting at least the ischial protuberances of riders of differing height and having different spacings between the ischial protuberances to be padded in different sitting positions.

3. The riding saddle according to claim 2, wherein said size of said surface of said elevations is at least 150 cm², or more than 200 cm² or more than 300 cm².

4. The riding saddle according to claim 1, wherein said elevations are each approximately kidney-shaped and are longer in a longitudinal direction than in a transverse direction of the saddle, and said depression runs in the longitudinal direction approximately in the center of the saddle and has a width of at least 2 cm.

5. The riding saddle according to claim 4, wherein said width of said depression is more than 4 cm or 4 to 10 cm.

6. The riding saddle according to claim 1, wherein said depression reaches as far as said basic saddle surface under said elevations and is disposed and dimensioned to position a rider's coccyx in a region above said depression during riding.

7. The riding saddle according to claim 1, wherein said elevations have rounded outer contours and are matched to a shape of the saddle.

8. The riding saddle according to claim 7, wherein said elevations have a surface, an approximately constant height over most of said surface and drop away toward said outer contours.

9. The riding saddle according to claim 8, wherein said approximately constant height of said elevations is between 5 and 40 mm or approximately 15 mm, and said elevations drop away toward said outer contours over an edge region with a width of 1 to 4 cm.

10. The riding saddle according to claim 1, wherein said two elevations are formed by two completely separate pads between which said depression is formed up to said basic saddle surface under said pads.

11. The riding saddle according to claim 1, which further comprises a seat region having said elevations and having a surface composed of a leather layer with no seams in vicinity of and between said elevations.

12. The riding saddle according to claim 11, wherein said leather layer has a thickness of 1 to 3 mm or approximately 2 to 2.2 mm.

13. The riding saddle according to claim 1, wherein said elevations are composed of foam.

14. The riding saddle according to claim 13, wherein said foam is polyurethane or polyethylene foam.

15. The riding saddle according to claim 1, wherein said basic saddle surface is formed by an underlayer and an intermediate layer disposed on said underlayer.

16. The riding saddle according to claim 15, wherein said underlayer is made of rubber and is approximately 14 mm thick, and said intermediate layer is made of jute fabric.

17. The riding saddle according to claim 1, which further comprises a leather layer forming a saddle surface, said elevations being adhesively bonded to a lower side of said leather layer.

18. The riding saddle according to claim 17, wherein said lower side of said leather layer in vicinity of said depression and lower sides of said elevations are adhesively bonded to said basic saddle surface.

19. The riding saddle according to claim 1, which further comprises a saddle tree determining said saddle structure, said saddle tree having straps to be tensioned for determining a seat shape.

20. The riding saddle according to claim 19, wherein said saddle tree is a flexible spring steel tree.
